(19) United States
(12) Patent Application Publication
(10) Pub. No.: US 2014/0236781 A1
(43) Pub. Date: Aug. 21, 2014

(54) Systems and Methods for an In-Memory Budget Finder

(71) Applicant: SAP AG, Walldorf (DE)

(72) Inventors: Ulrich Bestfleisch, Walldorf (DE); Jochen Mayerle, Walldorf (DE)

(73) Assignee: SAP AG, Walldorf (DE)

(21) Appl. No.: 13/768,890

(22) Filed: Feb. 15, 2013

(51) Int. Cl. G06Q 40/00

(52) U.S. Cl. CPC G06Q 40/12
USPC 705/30

(57) ABSTRACT

Systems and methods for automatically finding available funds in an in-memory database are disclosed. In response to receiving an proposed expenditure amount associated with a proposed budget identifier, a set of proximity rules can be determined. The proximity rules define a budget graph and the scope for a particular search. The budget graph defines relationships between budgets. The relationships between the budgets in the graphs can be based on a budget hierarchy or functions or purposes associated with the budgets. The scope can define an allowed degree of separation between a the proposed budget and a related budget in the graph that the search for funds will be permitted to traverse. Using the graph, multiple related budgets with available funds can be identified. The proposed budget expenditure amount can be allocated to one of the budgets with available funds instead of the budget associated with the proposed budget identifier.

### BACKGROUND

The present invention relates to financial management systems, and in particular, to systems and methods for automatically finding available funds in one or more related budgets.

Unless otherwise indicated herein, the approaches described in this section are not prior art to the claims in this application and are not admitted to be prior art by inclusion in this section.

Public sector and non-profit organizations, such as government agencies, schools, and universities, are typically required, by law or policy, to closely track spending of public, tax, or donated funds. For this reason, such public sector and nonprofit organizations carefully forecast and track various interrelated operational and purpose-specific budgets in view of known or expected available funds. Unlike private and publicly traded companies, which are allowed to distribute surplus funds as profits or dividends, public sector and nonprofit organizations are typically only allowed to use surplus or unused funds for accomplishing the organization's intended goals and purposes. However, public sector and nonprofit organizations can redistribute surplus funds. Funds originally allocated to one budget can be reallocated for expenditures associated with another related budget. In effect, when a public sector or nonprofit organization determines that it has run out of funds in a particular budget associated with a particular type of expenditure, such organizations can, subject to various rules and regulations, reassign that type of expenditure to a related budget that still has funds available.

Some public sector and nonprofit organizations use various types of accounting systems for tracking expenditures and budgets. Such systems track expenditures and budgets by associating each expenditure entered into the system with a budget, so that the cost of each expenditure can be deducted from the correct budget. To reduce the potential for unintended shortfalls, some accounting systems check to determine whether there are funds available in a budget specified in an expenditure entry, e.g. a purchase order request, a purchase order or a supplier invoice, before the entry is finalized or allowed to be saved. When there are funds available in the specified budget, there are no issues and the expenditure entry can be entered. However, when the initial check for funds in the budget specified in the expenditure entry reveals that there are no funds remaining, a user must manually check the availability of funds in related budgets.

Manually checking for available funds in related budgets is not only a time-consuming and highly repetitive process of trial and error, it also requires that the user knows which related budgets to check, based on relationships between budgets, regulations, and policies. Typically, only users who have in-depth organizational knowledge regarding the structure and relationship of the organization's budgets are capable, qualified, or authorized to search for additional available funds in this manner. Accordingly, manually checking for available funds in typical accounting systems requires a senior level accounting professional, rather than a staff accountant or clerk level user. Embodiments of the present disclosure address these and other issues.

### SUMMARY

Embodiments of the present disclosure include a method for automatically finding available funds that includes providing, in a computer system, an in-memory database that can include multiple budgets and multiple expenditure items, wherein the budgets can include multiple budget identifiers associated with multiple corresponding budget amounts, and wherein each of the expenditure items can include an expenditure amount associated with one of the budget identifiers. Such embodiments can also include receiving a proposed expenditure item can include a proposed expenditure amount associated with a budget identifiers, determining multiple related budget identifiers related to the budget identifier, searching the in-memory database for a first portion of the budgets that include budget identifiers determined to match at least one of the related budget identifiers, searching the in-memory database for a first portion of the expenditure items that include budget identifiers determined to match at least one of the related budget identifiers, determining multiple available budget amounts based on the first portion of the budgets and the first portion of the expenditure items, and comparing the proposed expenditure amount with each of the available budget amounts to determine a portion of the available budget amounts greater than the proposed expenditure amount.

In one embodiment of the present disclosure, determining the available budget amounts can include generating multiple aggregate expenditure amounts from the first portion of the expenditure items according to the related budget identifiers, wherein each of the aggregate expenditure amounts corresponds to one of the related budget identifiers, determining a portion of the corresponding budget amounts associated with the related budget identifiers, and comparing the aggregate expenditure amounts with the portion of the corresponding budget amounts, according to the related budget identifiers.

In one embodiment of the present disclosure, determining the related budget identifiers includes determining a graph for the budget identifiers, wherein the graph defines multiple connections among the budget identifiers, and searching the graph for a first portion of the budget identifiers determined to be connected to the budget identifier.

In one embodiment of the present disclosure, the connections among the budget identifiers in the graph can be based on an organizational hierarchy in an accounting system.

In one embodiment of the present disclosure, the connections among the budget identifiers in the graph can be based on multiple functions associated with the budget identifiers.

In one embodiment of the present disclosure, searching the graph for the first portion of the budget identifiers can include determining an allowed degree of separation in the graph between the budget identifier and the first portion of the budget identifiers determined to be connected to the budget identifier.

One embodiment of the present disclosure can further include associating the proposed expenditure item with one of the budget identifiers corresponding to one of the portion of the available budget amounts greater than the proposed expenditure amount.

One embodiment of the present disclosure includes a non-transitory computer-readable storage medium containing instructions that, when executed, control an computer processor to be configured for: providing an in-memory database that can include multiple budgets and multiple expenditure items, wherein the budgets can include multiple budget identifiers associated with multiple corresponding budget amounts, and wherein each of the expenditure items can include an expenditure amount associated with one of the budget identifiers; receiving a proposed expenditure item that can include a proposed expenditure amount associated with a budget identifier; determining multiple related budget identifiers related to the budget identifier; searching the in-memory database for a first portion of the budgets that include budget identifiers determined to match at least one of the related budget identifiers; searching the in-memory database for a first portion of the expenditure items that include budget identifiers determined to match at least one of the related budget identifiers; determining multiple available budget amounts based on the first portion of the budgets and the first portion of the expenditure items; and comparing the proposed expenditure amount with each of the available budget amounts to determine a portion of the available budget amounts greater than the proposed expenditure amount.

Another embodiment of the present disclosure includes a system that can include: one or more computer processors; and a non-transitory computer-readable storage medium containing instructions, that when executed, control the one or more computer processors to be configured for: providing an in-memory database that can include multiple budgets and multiple expenditure items, wherein the budgets can include multiple budget identifiers associated with multiple corresponding budget amounts, and wherein each of the expenditure items can include an expenditure amount associated with one of the budget identifiers; receiving a proposed expenditure item that can include a proposed expenditure amount associated with a budget identifier of the budget identifiers; determining multiple related budget identifiers related to the budget identifier; searching the in-memory database for a first portion of the budgets that include budget identifiers determined to match at least one of the related budget identifiers; searching the in-memory database for a first portion of the expenditure items that include budget identifiers determined to match at least one of the related budget identifiers; determining multiple available budget amounts based on the first portion of the budgets and the first portion of the expenditure items; and comparing the proposed expenditure amount with each of the available budget amounts to determine a portion of the available budget amounts greater than the proposed expenditure amount.

The following detailed description and accompanying drawings provide a better understanding of the nature and advantages of the present invention.

### BRIEF DESCRIPTION OF THE DRAWINGS

FIG. 1 is a schematic diagram of a system that includes an automatic budget finder according to one embodiment of the present invention.

FIG. 2 is a flowchart of a method for searching related budgets for available funds using an automatic budget finder according to one embodiment of the present invention.

FIG. 3 illustrates a hierarchical budget graph according to one embodiment of the present invention.

FIG. 4 illustrates a function based budget graph according to one embodiment of the present invention.

FIG. 5 illustrates an example of a function based budget graph according to one embodiment of the present invention.

FIG. 6 is a screenshot of a user interface of an accounting system that includes an automatic budget finder according to one embodiment of the present invention.

FIG. 7 is a screenshot of a user interface of an accounting system that includes an automatic budget finder according to one embodiment of the present invention.

FIG. 8 is a screenshot of a user interface of an accounting system that includes an automatic budget finder according to one embodiment of the present invention.

FIG. 9 is a schematic of an example computer system and networks that may be used to implement various embodiments of the present invention.

### DETAILED DESCRIPTION

Described herein are techniques for an in-memory database budget finder. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Overview

Embodiments of the present disclosure include systems that use automatic budget finders executed in accounting systems that use in-memory financial and accounting databases. In-memory databases, or main-memory database systems, are database management systems that primarily rely on the main-memory of a computer system. In-memory databases differ from database management systems that employ disk storage mechanisms. Specifically, in in-memory databases the majority, if not all, of the database records are loaded and stored in the volatile main-memory, e.g., random access memory (RAM), of the computer system. In-memory databases are faster than disk optimized databases because the internal optimization algorithms are simpler and require fewer processor resources. Accordingly, performing operations, such as aggregating and filtering, on in-memory databases with large numbers of records can be accomplished in near real-time. Such high speed processing of operations on in-memory databases is highly advantageous for various embodiments of the present disclosure.

Automatic budget finders can be incorporated into or called by various subsystems of an accounting system. For example, when a user enters an expenditure into an accounting system, the expenditure entry can specify the amount, the type of the expenditure, and an associated budget. The accounting system might determine, based on an initial check, that there are insufficient funds available for the particular type of expenditure in the specified budget, i.e. the funds remaining in the budget is less than the amount of the expenditure. In such scenarios, the budget finder can automatically search for available funds in multiple budgets related to the specified budget. Budgets can be related to the specified budget based on any data available to the accounting system. For example, the specified budget can be related to a number of other budgets based on factors including, but not limited to, the specified budget's relative positions in a chart of accounts, and the inclusion of the specified budget in or association with a government grant. The rules that define which budget are related and the order in which the budget finder checks the budgets can be determined by various proximity rules.

The proximity rules can define a budget graph in which the budgets or budget identifiers are the nodes of the graph, and the edges that connect the nodes define the relationships between the budgets, e.g., budgets that are directly or indirectly connected to one another via one or more edges and/or other budgets can be referred to as being related. The proximity rules can also define the scope of the search that a budget finder will perform. The scope of the search can be described in terms of the number of nodes, or steps, away from a specified starting budget that the budget finder will traverse in the search. For all the related budgets within the scope of search for a particular proximity rule, the budget finder can filer and aggregate accounting data to calculate, or otherwise determine, the remaining available funds in each of the related budgets. The budget finder can then display which budgets with sufficient funds to which the entered expenditure can be allocated. The user can then select one of the budgets and finalize the expenditure entry more quickly and efficiently than if the user had to manually hunt for a budget with sufficient funds.

In-Memory Budget Finder

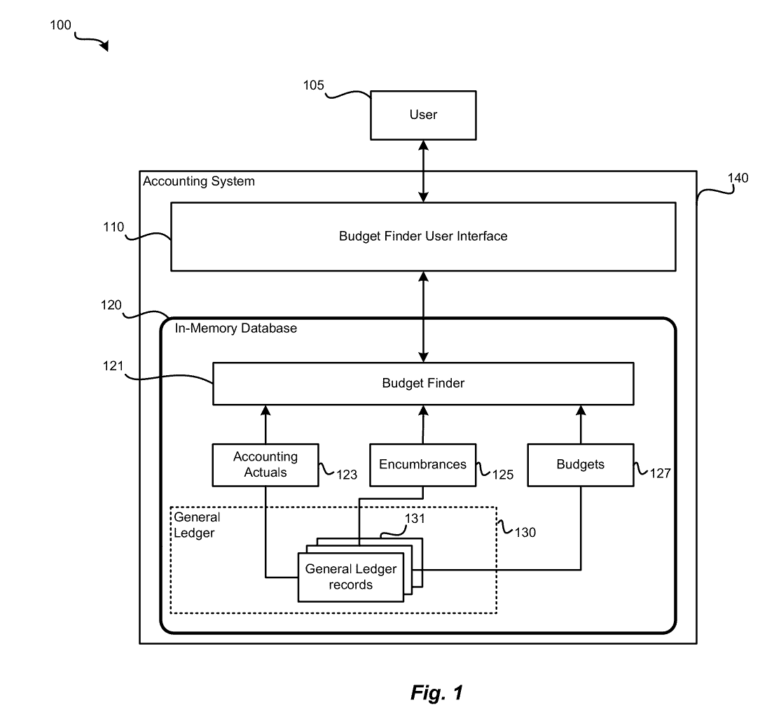

FIG. 1 illustrates a system 100 that includes an in-memory database budget finder 121, according to various embodiments. As shown, system 100 can include an accounting system 140. Accounting system 140 can include an in-memory database 120 that includes a budget finder 121, and general ledger records 131 of a general ledger 130. The general ledger records 131, which can include a very large number of expenditure items, can be loaded into and/or stored in the in-memory database 120. Each expenditure item can include an expenditure amount, e.g. a dollar amount, associated with a particular budget identifier. The budget identifier specified in the expenditure item can indicate a particular budget to which the associated expenditure amount is allocated. The accounting system 140 can be implemented as a combination of hardware, firmware, and software. Specifically, the accounting system 140 can be implemented as a software application executed by a processor of a computer.

The in-memory database 120 can include other applications or other functionality that can calculate, or otherwise determine, accounting actuals 123, encumbrances 125, and budgets 127 from the general ledger records 131. Use of in-memory database techniques and systems allow for fast, near real time, determination of filtered and aggregated information from the general ledger records. For example, the accounting actuals 123 can include timely aggregated information from the general ledger records 131 representing information regarding actual or realized expenditures, e.g., cleared checks, completed wire transfers, and posted electronic transactions, associated with various budgets. Encumbrances 125 can include continually updated aggregated information from the general ledger records 131 representing information regarding potential or promised expenditures, e.g., issued purchase order requests, issued purchase orders, received invoices, and other liabilities, associated with various budgets. Budgets 127 can include information regarding various budgets and the relationship to and dependency on other budgets.

In some embodiments, the budgets 127 can include a number of unique budget identifiers associated with corresponding budget amounts. For example, the budgets 127 can include budget identifiers, such as cost center descriptions, associated with a particular fund amount, e.g. a US dollar amount or other currency amount. In related embodiments, the budgets 127 can include one or more budget graphs that describe the relationships among the individual budgets. In such embodiments, the budget graphs can be based on the organizational hierarchy of the budgets. For example, budgets that are determined to be sub budgets, or portions of larger budgets, based on an associated organizational hierarchy can be related to one another in the budget graph according to that hierarchy. In other embodiments, the budget graph can be based on functional relationships, e.g. the nodes and edges of the graph can depend on specified functions associated with each one of the budgets. For example, budgets that are specified as being appropriated for the function of “Fire Control” will be associated with one another in a function-based budget graph.

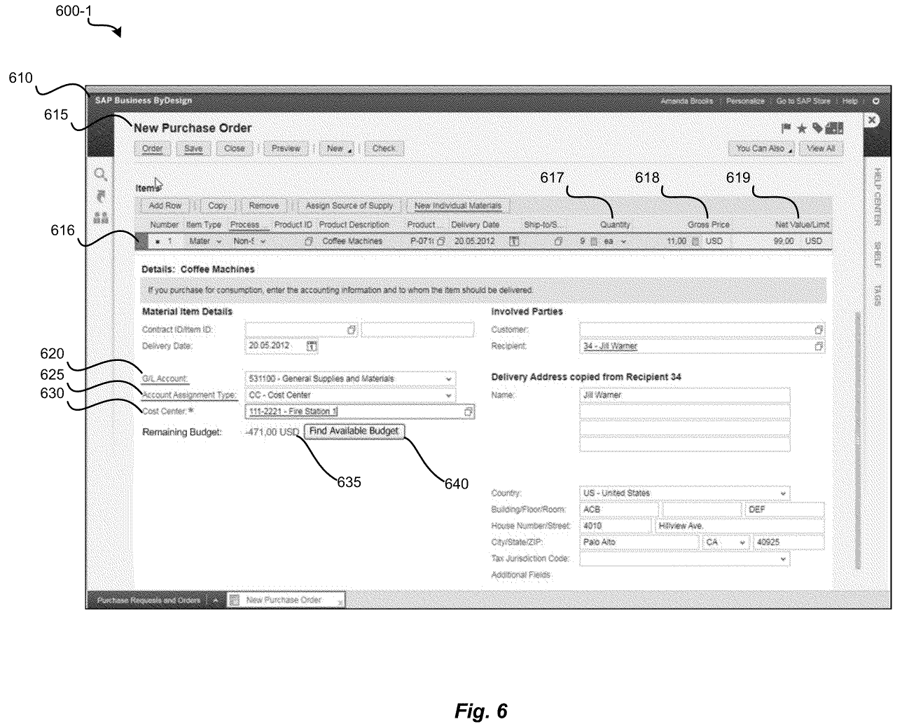

A user 105 can invoke or use the budget finder 121 using the budget finder user interface 110. In some embodiments, the budget finder user interface 110 can be incorporated into user interfaces of other applications or functions that operate in or on the in the in-memory database 120. For example, the budget finder user interface 110 can be included in a user interface the accounting system for entering invoices received from vendors. In such embodiments, the budget finder user interface 110 can include a control, such as a button rendered in a graphical user interface that the user can operate when the accounting system 140 determines that there are no remaining funds in a budget specified in an expenditure entry. For example, the accounting system 140 can perform filtering, aggregating, and other functions on general ledger records 130 to check if there are remaining available funds in the budget identified in a particular expenditure entry, e.g., in the entry of a particular invoice. If the check of the budget identified in the particular expenditure entry indicates that there are no remaining funds in that particular budget, the button rendered in the graphical user interface of the accounting system 140 can be activated so a user can invoke additional aspects or controls of the budget finder user interface 110. In one embodiment, a “Find Available Budget” button can be rendered in the graphical user interface of the accounting system 140. When the “Find Available Budget” button is operated, the accounting system can display a new window or view of the budget finder user interface in the graphical user interface. Example accounting system 140 user interfaces and budget finder user interfaces are described in more detail in reference to FIGS. 6-8.

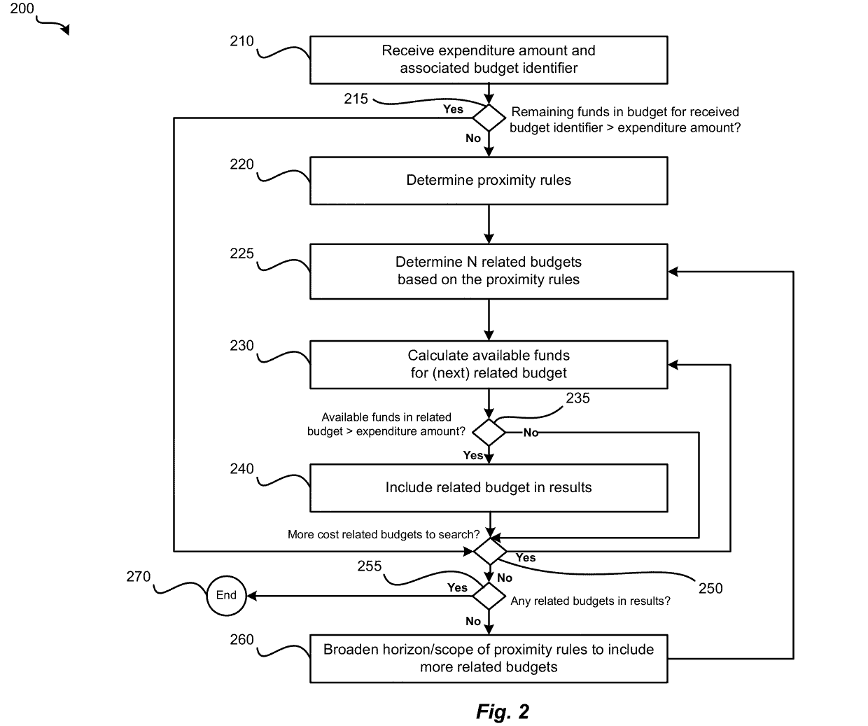

FIG. 2 illustrates a flowchart of a method 200 for finding funds in an accounting system, according to various embodiments of the present disclosure. As shown, method 200 can begin at action 210 in which the accounting system 140 can receive an expenditure item that includes an expenditure amount and an associated budget identifier, through one or more user interfaces. The user interface can be generated by or associated with any one of multiple applications of the accounting system 140. For example, the user can enter a purchase order as a particular expenditure item in a purchase order entry application user interface. The amount of the purchase order can be allocated to a particular budget. Accordingly, the expenditure item that represents the purchase order can include an expenditure amount associated with the budget identifier of the budget to which the purchase order amount will be allocated.

In determination 215, the accounting system 140 can check the budget to determine if the remaining available funds in the budget are greater than the expenditure amount. In one embodiment, checking the remaining funds in the budget can include filtering all expenditures item from the in-memory database allocated to the budget, i.e., expenditure items that include the budget identifier associated with the budget. The accounting system 140 can then aggregate the amounts of the filtered expenditures items and calculate the total amount allocated to the budget. The remaining funds in the budget can then be calculated by subtracting the total amount of the filtered expenditure amounts from the budget amount. If the difference is greater than the expenditure amount, then the accounting system can determine there are funds available in the budget. If the difference is less than the expenditure amount, then the accounting system 140 can determine are insufficient funds available in the budget.

If there are funds available in the budget indicated by the budget identifier, the method can move to determination 250 to determine whether or not there are more expenditure items to process or enter into the accounting system 140. If there are no more expenditure items to enter into the accounting system 140, then the method can move on to determination 255 to determine if there was a budget discovered with available funds. In this particular sequence, since the initial check performed by the accounting system 140 found that there were available funds in the budget indicated in the expenditure item, then method 200 can end at position 270.

If there are insufficient funds in the budget, the method can proceed to action 220. In action 220, the budget finder 121 can determine proximity rules. In action 220, the budget finder 121 can determine one or more proximity rules associated with the particular budget identifier and/or with the particular user interface of the accounting system 140 through which the particular expenditure item was received. In some embodiments, determining the proximity rules can include looking up a predetermined set of proximity rules associated with the budget identifier in the accounting system 140. Accordingly, the accounting system 140 can include multiple predetermined sets of proximity rules associated with corresponding budget identifiers. Each predetermined set of proximity rules can be unique for each budget identifier. Alternatively, the proximity rules can be the same or include a default set of proximity rules for all budget identifiers in the accounting system 140. Accordingly, the particular set of proximity the proximity rules can be based on policies, rules, regulations, or organizational requirements of the accounting system 140 or the organization that uses the accounting system 140. In yet other embodiments, the proximity rules in the account system 140 can include a collection of default and unique predetermined sets of proximity rules associated with corresponding budget identifiers.

In some embodiments, determining the proximity rules can include determining a particular graph that associates the various budgets 127 in the in-memory database with one another. For example, one particular budget identifier can be associated with proximity rules that include a hierarchical budget graph, in which the budgets 127 are related to one another according to a predetermined budget hierarchy. In budget hierarchies, budgets can be defined as being portions or percentages of larger budgets. Accordingly, each budget in a hierarchical budget graphs can be related to larger budgets, going up in the hierarchy, as well as to smaller budgets, going down in the hierarchy. In related embodiments, determining the proximity rules can also include determining the number of levels or steps that the budget finder 121 will go up and down in the budget graph to find budgets with available funds. The number of levels or steps in the budget graph the budget finder 121 will traverse can be referred to as the scope or horizon of the proximity rule. For example, the scope of the proximity rule that includes a hierarchical budget graph can specify that the budget finder 121 go up one level or steps in the hierarchy, but go down two levels or steps in the hierarchy, relative to the starting budget, to find a budget with available funds. Even budgets that are associated with proximity rules that include the same budget graph, the scope of the proximity rule can be associated or based on the budget associated with entered budget identifier.

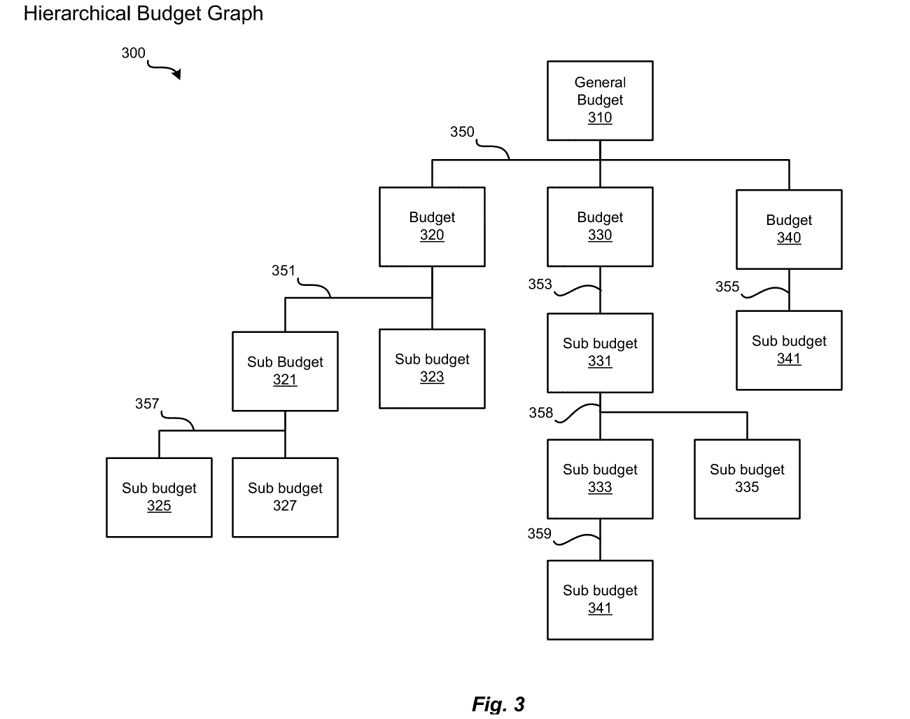

The proximity rules can also include a function based budget graph. In function based budget graphs, budgets are related to one another based on their specified purpose or function within the overall budget. For example, for a particular municipality, budgets within the accounting system 140 can be designated as being intended for fire suppression. Accordingly, any and all budgets within the accounting system 140 that are designated for fire suppression can be associated with one another in the function based budget graph. In some embodiments, aspects of the function based budget graph can include various aspects of the hierarchical budget graphs, such that budgets that are related by function type can also be related to budgets above and below the functionally related budgets in the organizational hierarchy graph. Accordingly, some budget graphs can be hybrid budget graphs that include characteristics and relationships between the budgets that function based and hierarchical. The budget graphs are discussed in more detail in reference to FIG. 3-5 below.

Determining the proximity rules for a particular budget identifier can also include determining an order in which related budgets will be checked for available funds. In one particular embodiment, the budgets can be checked according to an order derived from the budget graph associated with the budget identifier. For hierarchical budget graphs, the order in which the budgets are checked can be defined by first going down in the hierarchy, and then going up in the hierarchy. In other embodiments, in which the budget graph is a function based budget graph, the order in which the related budgets are checked can be arbitrary or based on a systematic organization, e.g., alphabetical or numerical order of the budget identifiers associated with each of the related budgets.

In action 225, the budget finder 121 can reference the determined proximity rule determined in action 220 to determine a number of related budgets. In some embodiments, determining the number of related budgets can include analyzing a budget graph to determine which budgets, within the specified scope, are related to the budget indicated by the budget identifier in the expenditure item. The analysis of the budget graph according to the scope can result in set of ordered budget identifiers that the budget finder can reference when querying the general ledger records 131 in the in-memory database.

In action 230, the budget finder 121 can calculate the remaining funds for one of the related budgets. In some embodiments, the order in which the related budgets are check can be included in the proximity rules. To calculate the remaining funds for a particular related budget, the budget finder 121 can query, filter, and/or aggregate expenditure items stored in the general ledger records 131. The following algorithm can be used:

Available Funds(BID,FY,G/L Acct,Fcn)=Budget Amount(BID,FY,G/L Acct,Fcn)−Encumbrances(BID,FY,G/L Acct,Fcn)−Actuals(BID,FY,G/L Acct,Fcn)

Where, BID=budget identifier, FY=fiscal year, G/L Acct=general ledger account, and Fcn=function. In some embodiments, the value for BID defaulted to the budget identifier indicated in the expenditure item entry. The value for FY can be defaulted to be the current fiscal year, unless otherwise indicated in the expenditure item entry. The value for G/L Acct can default to be the general ledger account indicated in the expenditure item entry, unless otherwise indicated by a user or required by the accounting system 140. The value for Fcn can be the function associated with or assigned to the budget indicated by budget identifier in the expenditure item entry.

At determination 235, the budget finder 121 can determine whether the available funds for a particular related budget is sufficient, i.e., greater than the expenditure amount. If sufficient funds not are available in the related budget, the method can repeat action 230 for the next related budget according to the order defined by the proximity rules. If the related budget has funds available for the particular expenditure item, then in action 240, the budget identifier for that particular budget can be included in the list of results. If it is determined at determination 250 there are more related budgets to check for available funds, the method 200 can be repeated from actions 230 through 240 for all of the related budgets.

When all of the related budgets have been checked for available funds, and determination 215 determines that there are no additional related budgets to check, then the budget finder 221 can determine whether or not any of the related budgets checked returned results indicating available funds. In some embodiments, determining if any of the check budgets had sufficient available funds can include checking the list of results compiled in action 240. If funds were found in any one or more of the related budgets, than the method 200 can and at position 270.

However, if no funds were found in any of the one or more related budgets, then the budget finder 121 can broaden the scope of the proximity rules to include more related budgets. For example, if the budget finder 121 checked budgets located two steps up and two steps down in the hierarchical budget graph from the initial budget, then the budget finder 121 can automatically, or in response to user input, check budgets three steps up and three steps down in the hierarchical budget graph for available funds. When the scope of the proximity rules is expanded, the budget finder 121 can repeat actions 225 through 255. The scope of the proximity rules can be incrementally increased until available funds are found in one or more related budgets.

Budget Graphs

FIG. 3 illustrates an example hierarchical budget graph 300, according to various embodiments of the present disclosure. The structure of the hierarchical budget graph 300 can be based on a hierarchy set up in the general budget 310. The graph 300 can include a number of budgets and sub budgets as the nodes of the graph. The nodes that are connected to one another by edges, or connections, of the graph that define the hierarchical relationship between the budgets and sub budgets.

As shown, the hierarchical budget graph 300 includes a general budget 310 from which all other budgets are derived. In some embodiments, the general budget 310 represents all available funds. Budget 320, budget 330, and budget 340 are all related to the general budget 310 by relationship connection 350. In such embodiments, general budget 310 is referred to as being related to and being one step up in the hierarchical budget graph 300 from budgets 320, 330, and 340. Similarly sub budget 321 and sub budget 323 are related to budget 320 by connection 351, and referred to as being related to and being one step down in the hierarchical budget graph 300 from budget 320. Finally sub budget 325 and sub budget 327 are related to sub budget 321 by connection 357, and referred to as being related to and being two steps down in the hierarchical budget graph from budget 320.

The structure of hierarchical budget graph 300, also includes a number of relationships between budget 330 and other sub budgets. For example, some budget 331 is connected to budget 330 via connection 353. Further down in the hierarchical budget graph 300, sub budgets 330 and 335 are one step down from sub budget 331 as indicated by connection 358. Sub budgets 341 is two steps down from sub budget 331, as indicated by connection 359, intermediate sub budget 333, and connection 358. Accordingly, the number of intermediate connections between one budget and another budget determines the number of steps or levels away that two budgets are from one another in the hierarchical budget graph. The number of steps by which two budgets are separated from one another can be referred to as the degree of separation, e.g. two budgets that are separated from one another by three steps can be referred to as being separated by three degrees of separation, such as sub budget 341 and budget 330. Similarly, the budget pair that includes sub budget 340 connected to budget 341 by connection 355, is referred to as having only one degree of separation.

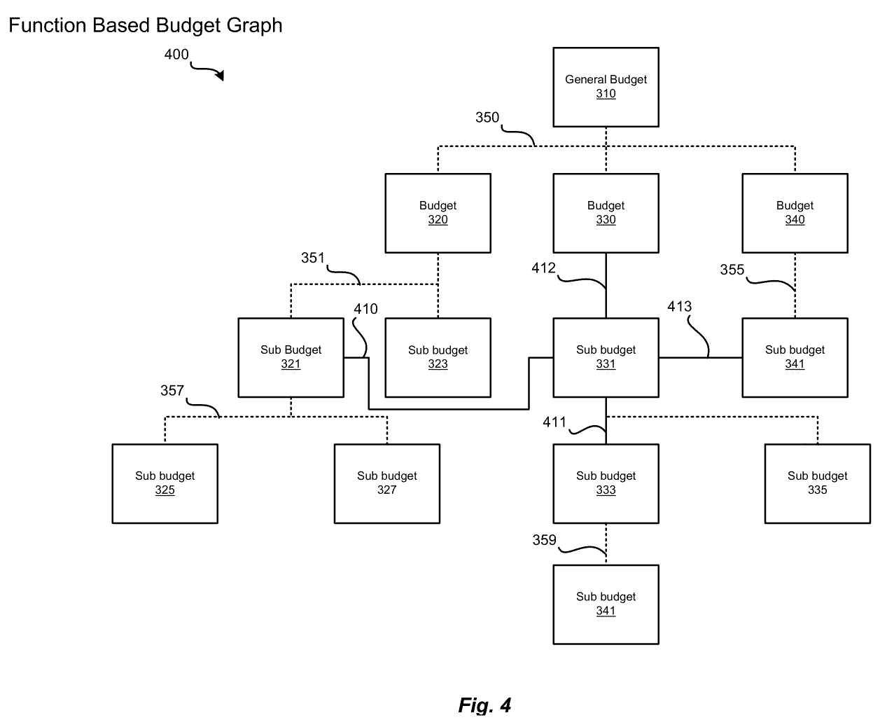

FIG. 4 illustrates an example of a function based budget graph 400, according to various embodiments. The function based budget graph 400 can be based on the same organizational hierarchy associated with the general budget 310, in that it can include the same budgets as the budgets described in reference to FIG. 3. However, the edges, or connections, of the graph 400 are not defined by the hierarchical relationships between the budgets, but rather by the designated functions associated with each budget. Accordingly, the connections discussed in reference to FIG. 3 are shown as dotted lines to indicate that those connections are not the defining connections of the function based budget graph 400. Rather the function based relationships among the budgets are defined by connections 410, 411, 412, and 413 among sub budgets 321, 331, 333, 341, and budget 330. The connections 410-413 are established based on the determination or designation that each of sub budgets 321, 331, 333, 341, and budget 330 are all designated as having the same function or purpose within the general budget 310. Each of the budgets and sub budgets in the general budget 310 can be designated for particular function or purpose by an association with a function identifier.

In the particular example shown in FIG. 4, sub budget 331 can be related to sub budgets 321, 333, and 341 and budget 330 by connections 410, 411, 413 and 412, respectively, because each of the budgets are associated with the same function identifier. In some embodiments, the degree of separation between the various related budgets is not relevant with respect to the budget finder checking for available funds. In such embodiments, the budget finder can simply look for available funds in each one of the budgets in any order. Alternatively, the order in which the budget finder 121 searches the related budgets in a function based budget graph 400 can be predetermined or dynamically determined based on a nearest neighbor selection process. For example, if there are insufficient available funds and sub budget 321 for a particular expenditure item, the budget finder 121 may first check sub budget 331 because it is the closest neighbor, e.g. sub budget 331 and some budget 321 are separated by only one degree of separation. If the budget finder 121 finds that there are no available funds in sub budget 331 for the particular expenditure item, the budget finder 121 can also check budget 330, sub budget 341 and sub budget 333, all of which are the next nearest neighbors to sub budget 321 in the function based budget graph 400. The order in which the next nearest neighbors in a function based budget graph are checked can be based on the underlying hierarchical budget graph. In such embodiments, the budget finder 121 can be configured to check budgets further down in the organizational hierarchy first. In the example shown, the budget finder 121 would check sub budget 333 after checking sub budget 331. In other embodiments, the budget finder 121 can be configured to check budgets in the same level of the organizational hierarchy first. In such embodiments, the budget finder 121 would check some budget 341 first after checking sub budget 331 for available funds for particular expenditure item. Finally, the budget finder 121 can be configured to check budgets in higher levels of the organizational hierarchy first. Accordingly, the budget finder 121 can be configured to budget 330 first after checking sub budget 331 for available funds. In other embodiments, the order in which the budget finder 121 checks related budgets in a function based budget graph can be arbitrary.

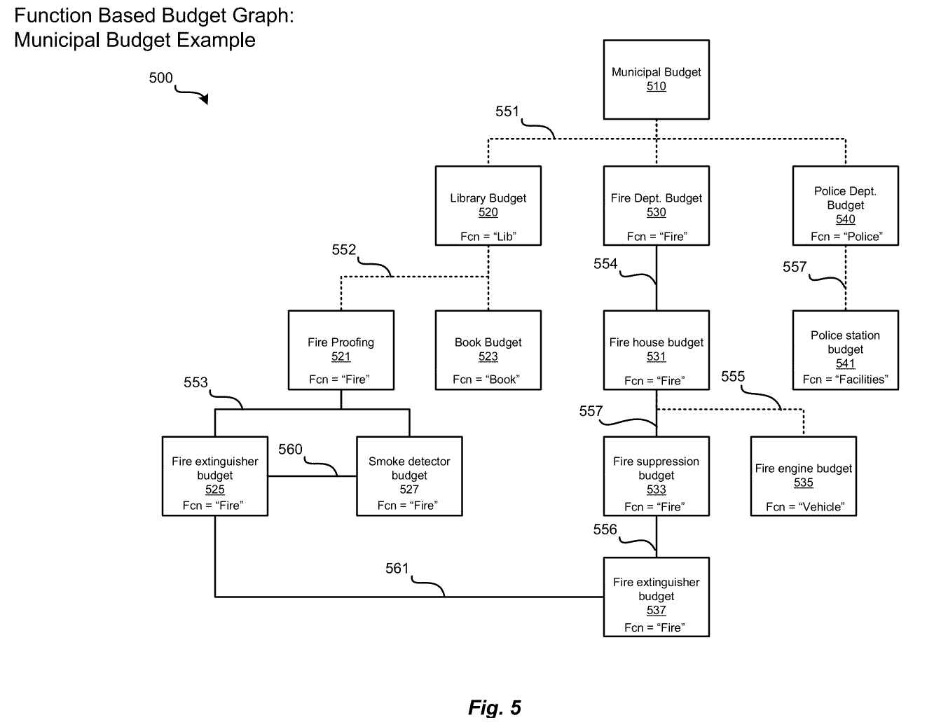

FIG. 5 illustrates a specific example of a function based budget graph 500. From which all other budgets and sub budgets are derived. Each of the budgets and sub budgets in the graph 500 are all associated with or include a function identifier. For example, the library budget 520 is associated with the function identifier “Lib”, the fire department budget 530 is associated with the function identifier “Fire”, and the police department budget 540 is associated with a function identifier “Police”. The library budget 520, the fire department budget 530, and the police department budget 540 are connected to the municipal budget 510 by connection 551. Connection 551 can be determined by the organizational hierarchy and the relationship between the budgets 521, 530, and 540 and the municipal budget 510 within the organizational hierarchy. However, connections 551, 552, 554, 555, and 557 are derived from the organizational hierarchy but are not the connections that define the function based budget graph 500 (as indicated by the dotted lines). Rather, the budgets in the function based budget graph 500 that are connected to one another are determined by commonalities that include a matching function identifier value. In the particular example shown, fireproofing budget 521, fire extinguisher budget 525, smoke detector budget 527, fire department budget 530, firehouse budget 531, fire suppression budget 533, and fire extinguisher budget 537 each include the function identifier “Fire”. Accordingly budgets 521, 525, 527, 530, 531, and 533 can be are related to one another by connections 553, 554, 556, 557, 560, and 561. If the budget finder 121 determines that fire extinguisher budget 525, associated with the library budget 520 in the organizational hierarchy by connection 552 and 553, does not have sufficient available funds to purchase or maintain fire extinguishers for the library, the budget finder 121 can check any and all of the other budgets that include the function identifier “Fire”. Accordingly, the budget finder 121 can check the firehouse extinguisher budget 537, and the fire suppression budget 533 that would normally be associated with the fire department budget 530 according to the organizational hierarchy, and therefore not otherwise normally be available to budgets associated with library budget 520. While the budgets of the function based budget graph 500 are shown as only including a single function identifier, various embodiments include variations in which some or all of the budgets are associated with multiple function identifiers to create more complex and comprehensive function based budget graphs, according to the internal policies, regulations, and laws applicable to the general budget of a particular organization.

FIG. 6 depicts a screenshot 600-1 of user interface 610 that includes a control 640 for invoking or activating budget finder 121, according to various embodiments. As shown, user interface 610 can include a user interface 615 of an application for entering a new purchase order into accounting system 140. When a user selects the “Ad Row” control 614, the user can be prompted to enter in the specifics shown in row 616. As shown, row 616 can include a purchase order for a quantity 617 of coffee machines, at a gross price 618 that results in a net value 619. Specifically, the purchase order represented by row 616 calls for a quantity of 9 coffeemakers that cost USD $11 each, and the results in a net purchase price of USD $99. Using the user interface 615, a user can enter other specifics regarding the newly created purchase order represented by row 616. For example, a user can enter a general ledger account identifier into the general ledger account field 620, a value into the account assignment type 625, as well as a budget identifier into the cost center field 630. As discussed above, the accounting system 140 can check to determine if there are funds available in the budget indicated by the budget identifier entered into cost center field 630. In this particular example, the accounting system 140 determined that the budget indicated in the cost center field 630 is over budget by USD $471, as indicated in the remaining budget field 635. Accordingly, the purchase order represented by row 616 cannot be allocated to the desired budget. In such scenarios, a user can select the “Find Available Budget” control 640.

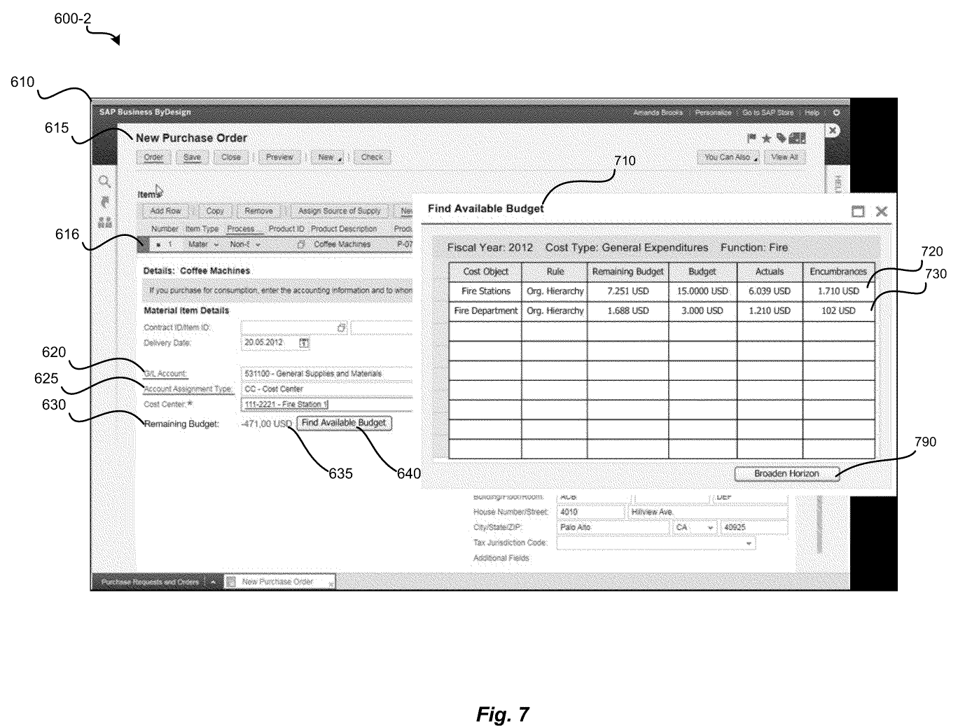

FIG. 7 depicts a screenshot 600-2 of user interface 610 that includes the user interface 615 referenced in FIG. 6, after a user has clicked or otherwise selected “Find Available Budget” button 640. In response to receiving user input through the “Find Available Budget” button 640, the budget finder 121 can generate and display the budget finder user interface 110 depicted as user interface 710. User interface 710 shows a number of entries 720 and 730 for budgets that were determined to include sufficient available funds for the expenditure amount specified in the newly created purchase order. As shown, user interface 710 includes two results 720 and 730 for budgets that include available funds determined by the budget finder 121 checking a hierarchical budget graph with a particular scope. In the particular example shown, the cost objects, or budgets, called “Fire Stations” and “Fire Department” were determined to be related with the cost object, or budget, “Fire Station 1” within the hierarchical budget graph. In some scenarios, even if one or more budgets with sufficient available funds are found within the initial scope of the proximity rules, a user may wish to broaden the scope, or “horizon”, of the budget finder search. Accordingly, some embodiments of the present disclosure include a “Broaden Horizon” button 790 in the user interface 710 that a user can operate to change the scope or relational budget graph to search for additional budgets with available funds.

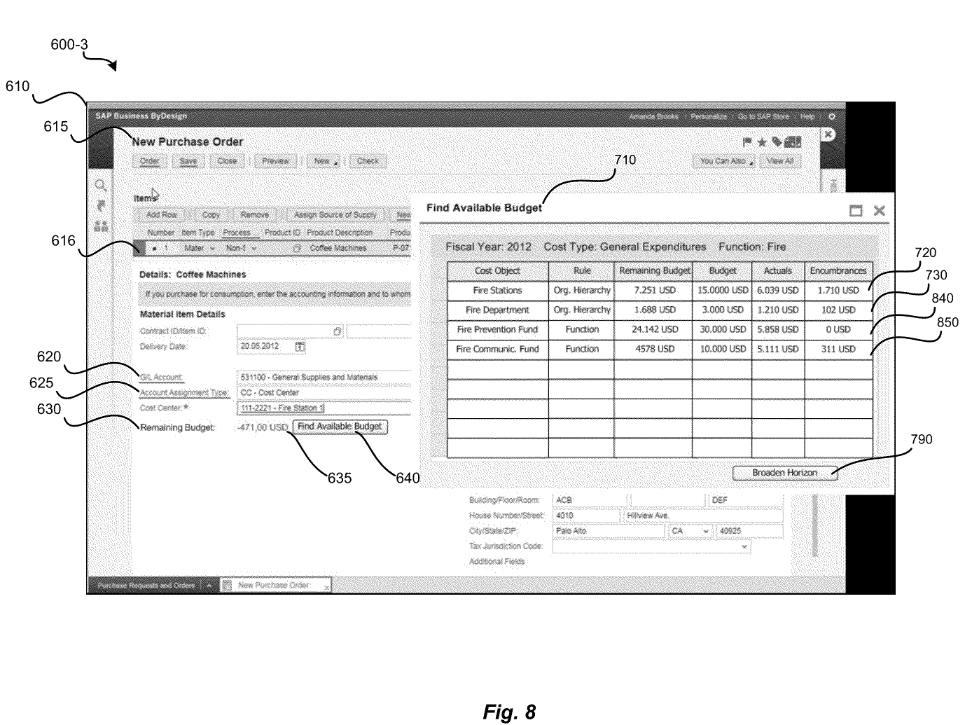

Broadening the scope of the search can include increasing the allowable degree of separation between related budgets within a particular relational budget graph. However, broadening the scope of the search can also include searching a different relational budget graph. For example, screenshot 600-3 of FIG. 8 shows user interface 710 displaying the results determined by budget finder 121 in response to user input received through the “Broaden Horizon” button 790. In this particular example, broadening the horizon, or the scope, of the budget finder's search included searching budgets related to “Fire Station 1” in a function based budget graph to discover lines 840 and 850 that include budgets “Fire Prevention Fund” and the “Fire Communication Fund”. Using the user interface 710, a user can select one or more of the budgets with available funds shown in lines 720, 730, 840 or 850, to which the new purchase order represented in row 616 will be allocated.

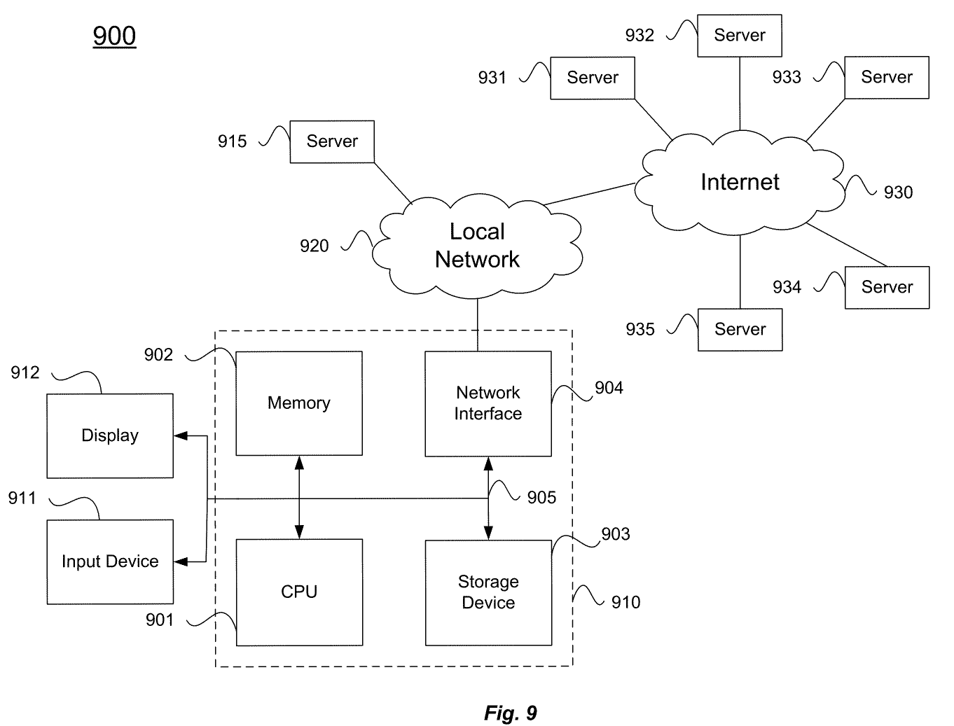

FIG. 9 illustrates an example computer system and networks that may be used to implement one embodiment of the present invention. Computer system 910 includes a bus 905 or other communication mechanism for communicating information, and a processor 901 coupled with bus 905 for processing information. Computer system 910 also includes a memory 902 coupled to bus 905 for storing information and instructions to be executed by processor 901, including instructions for performing the techniques described above. This memory may also be used for storing temporary variables or other intermediate information during execution of instructions to be executed by processor 901. Possible implementations of this memory may be, but are not limited to, random access memory (RAM), read only memory (ROM), or both. A storage device 903 is also provided for storing information and instructions. The information instructions can be in the form of computer readable code stored on the storage device, accessible and executable by processor to implement various techniques and methods of the present disclosure. Common forms of storage devices include non-transient, non-volatile computer readable media, for example, a hard drive, a magnetic disk, an optical disk, a CD, a DVD, a flash memory, a USB memory card, or any other medium from which a computer can read.

Computer system 910 may be coupled via the same or different information bus, such as bus 905, to a display 912, such as a cathode ray tube (CRT) or liquid crystal display (LCD), for displaying information. An input device 911 such as a keyboard and/or mouse is coupled to a bus for communicating information and command selections from the user to processor 901. The combination of these components allows the user to communicate with the system.

Computer system 910 also includes a network interface 904 coupled with bus 905. Network interface 904 may provide two-way data communication between computer system 910 and the local network 920. The network interface 904 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 904 sends and receives electrical, electromagnetic, or optical signals that carry digital data streams representing various types of information.

Computer system 910 can send and receive information, including messages or other interface actions, through the network interface 904 to an Intranet or the Internet 930. In the Internet example, software components or services may reside on multiple different computer systems 910 or servers 931 across the network. Software components described above may be implemented on one or more servers. A server 931 may transmit messages from one component, through Internet 930, local network 920, and network interface 904 to a component or container on computer system 910, for example. Software components of a composite application may be implemented on the same system as other components, or on a different machine than other software components. This process of sending and receiving information between software components or one or more containers may be applied to communication between computer system 910 and any of the servers 931 to 935 in either direction. It may also be applied to communication between any two servers 931 to 935.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
providing, in a computer system, an in-memory database comprising a plurality of budgets and a plurality of expenditure items, wherein the plurality of budgets comprises a plurality of budget identifiers associated with a plurality of corresponding budget amounts, and wherein each of the plurality of expenditure items comprises an expenditure amount associated with one of the plurality of budget identifiers;
receiving, in the computer system, a proposed expenditure item comprising a proposed expenditure amount associated with a first budget identifier in the plurality of budget identifiers;
determining, in the computer system, a plurality of related budget identifiers related to the first budget identifier;
searching, in the computer system, the in-memory database for a first portion of the plurality of budgets comprising budget identifiers determined to match at least one of the plurality of related budget identifiers;
searching, in the computer system, the in-memory database for a first portion of the plurality of expenditure items comprising budget identifiers determined to match at least one of the plurality of related budget identifiers;
determining, in the computer system, a plurality of available budget amounts based on the first portion of the plurality of budgets and the first portion of the plurality of expenditure items; and
comparing, in the computer system, the proposed expenditure amount with each of the plurality of available budget amounts to determine a portion of the plurality of available budget amounts greater than the proposed expenditure amount.

2. The method of claim 1 wherein determining the plurality of available budget amounts comprises:
generating a plurality of aggregate expenditure amounts from the first portion of the plurality of expenditure items according to the plurality of related budget identifiers, wherein each of the plurality of aggregate expenditure amounts corresponds to one of the related budget identifiers;
determining a portion of the plurality of corresponding budget amounts associated with the plurality of related budget identifiers; and
comparing the plurality of aggregate expenditure amounts with the portion of the plurality of corresponding budget amounts, according to the plurality of related budget identifiers.

3. The method of claim 1 wherein determining the plurality of related budget identifiers comprises:
determining a graph for the plurality of budget identifiers, wherein the graph defines a plurality of connections among the plurality of budget identifiers; and
searching the graph for a first portion of the plurality of budget identifiers determined to be connected to the first budget identifier.

4. The method of claim 3 wherein the plurality of connections among the plurality of budget identifiers in the graph is based on an organizational hierarchy in an accounting system.

5. The method of claim 3 wherein the plurality of connections among the plurality of budget identifiers in the graph is based on a plurality of functions associated with the plurality of budget identifiers.

6. The method of claim 3 wherein searching the graph for the first portion of the plurality of budget identifiers comprises determining an allowed degree of separation in the graph between the first budget identifier and the first portion of the plurality of budget identifiers determined to be connected to the first budget identifier.

7. The method of claim 1 further comprising associating the proposed expenditure item with one of the plurality of budget identifiers corresponding to one of the portion of the plurality of available budget amounts greater than the proposed expenditure amount.

8. A non-transitory computer-readable storage medium containing instructions that, when executed, control an computer processor to be configured for:
providing an in-memory database comprising a plurality of budgets and a plurality of expenditure items, wherein the plurality of budgets comprises a plurality of budget identifiers associated with a plurality of corresponding budget amounts, and wherein each of the plurality of expenditure items comprises an expenditure amount associated with one of the plurality of budget identifiers;
receiving a proposed expenditure item comprising a proposed expenditure amount associated with a first budget identifier in the plurality of budget identifiers;
determining a plurality of related budget identifiers related to the first budget identifier;
searching the in-memory database for a first portion of the plurality of budgets comprising budget identifiers determined to match at least one of the plurality of related budget identifiers;
searching the in-memory database for a first portion of the plurality of expenditure items comprising budget identifiers determined to match at least one of the plurality of related budget identifiers;
determining a plurality of available budget amounts based on the first portion of the plurality of budgets and the first portion of the plurality of expenditure items; and
comparing the proposed expenditure amount with each of the plurality of available budget amounts to determine a portion of the plurality of available budget amounts greater than the proposed expenditure amount.

9. The non-transitory computer-readable storage medium of claim 8 wherein determining the plurality of available budget amounts comprises:
generating a plurality of aggregate expenditure amounts from the first portion of the plurality of expenditure items according to the plurality of related budget identifiers, wherein each of the plurality of aggregate expenditure amounts corresponds to one of the related budget identifiers;
determining a portion of the plurality of corresponding budget amounts associated with the plurality of related budget identifiers; and
comparing the plurality of aggregate expenditure amounts with the portion of the plurality of corresponding budget amounts, according to the plurality of related budget identifiers.

10. The non-transitory computer-readable storage medium of claim 8 wherein determining the plurality of related budget identifiers comprises:
determining a graph for the plurality of budget identifiers, wherein the graph defines a plurality of connections among the plurality of budget identifiers; and
searching the graph for a first portion of the plurality of budget identifiers determined to be connected to the first budget identifier.

11. The non-transitory computer-readable storage medium of claim 10 wherein the plurality of connections among the plurality of budget identifiers in the graph is based on an organizational hierarchy in an accounting system.

12. The non-transitory computer-readable storage medium of claim 10 wherein the plurality of connections among the plurality of budget identifiers in the graph is based on a plurality of functions associated with the plurality of budget identifiers.

13. The non-transitory computer-readable storage medium of claim 8 wherein searching the graph for the first portion of the plurality of budget identifiers comprises determining an allowed degree of separation in the graph between the first budget identifier and the first portion of the plurality of budget identifiers determined to be connected to the first budget identifier.

14. The non-transitory computer-readable storage medium of claim 13 wherein the instructions that, when executed, control the computer processor to be further configured for associating the proposed expenditure item with one of the plurality of budget identifiers corresponding to one of the portion of the plurality of available budget amounts greater than the proposed expenditure amount.

15. A system comprising:
one or more computer processors; and
a non-transitory computer-readable storage medium containing instructions, that when executed, control the one or more computer processors to be configured for:
providing an in-memory database comprising a plurality of budgets and a plurality of expenditure items, wherein the plurality of budgets comprises a plurality of budget identifiers associated with a plurality of corresponding budget amounts, and wherein each of the plurality of expenditure items comprises an expenditure amount associated with one of the plurality of budget identifiers;
receiving a proposed expenditure item comprising a proposed expenditure amount associated with a first budget identifier in the plurality of budget identifiers;
determining a plurality of related budget identifiers related to the first budget identifier;
searching the in-memory database for a first portion of the plurality of budgets comprising budget identifiers determined to match at least one of the plurality of related budget identifiers;
searching the in-memory database for a first portion of the plurality of expenditure items comprising budget identifiers determined to match at least one of the plurality of related budget identifiers;
determining a plurality of available budget amounts based on the first portion of the plurality of budgets and the first portion of the plurality of expenditure items; and
comparing the proposed expenditure amount with each of the plurality of available budget amounts to determine a portion of the plurality of available budget amounts greater than the proposed expenditure amount.

16. The system of claim 15 wherein determining the plurality of available budget amounts comprises:
generating a plurality of aggregate expenditure amounts from the first portion of the plurality of expenditure items according to the plurality of related budget identifiers, wherein each of the plurality of aggregate expenditure amounts corresponds to one of the related budget identifiers;
determining a portion of the plurality of corresponding budget amounts associated with the plurality of related budget identifiers; and
comparing the plurality of aggregate expenditure amounts with the portion of the plurality of corresponding budget amounts, according to the plurality of related budget identifiers.

17. The system of claim 15 wherein determining the plurality of related budget identifiers comprises:
determining a graph for the plurality of budget identifiers, wherein the graph defines a plurality of connections among the plurality of budget identifiers; and
searching the graph for a first portion of the plurality of budget identifiers determined to be connected to the first budget identifier.

18. The system of claim 17 wherein the plurality of connections among the plurality of budget identifiers in the graph is based on an organizational hierarchy in an accounting system.

19. The system of claim 17 wherein the plurality of connections among the plurality of budget identifiers in the graph is based on a plurality of functions associated with the plurality of budget identifiers.

20. The system of claim 15 wherein searching the graph for the first portion of the plurality of budget identifiers comprises determining an allowed degree of separation in the graph between the first budget identifier and the first portion of the plurality of budget identifiers determined to be connected to the first budget identifier.
